(19) United States
(12) Patent Application Publication
(10) Pub. No.: US 2006/0112421 A1
(43) Pub. Date: May 25, 2006

(54) Smart card systems and methods for building automation

(76) Inventors: William T. Beierwalters, Loveland, CO (US); John McDermid, Loveland, CO (US)

Correspondence Address: TRENNER LAW FIRM, LLC, 12081 WEST ALAMEDA PARKWAY #163, LAKEWOOD, CO, 80228, US

(21) Appl. No.: 10/996,028

(22) Filed: Nov. 23, 2004

(51) Int. Cl. H04L 9/32

(52) U.S. Cl. 726/5

(57) ABSTRACT

Implementations described and claimed herein enable smart card systems and methods for building automation. An exemplary smart card system includes an interface device communicatively coupled to a plurality of automation devices. Control circuitry is provided for the interface device to receive user credentials from a smart card when the smart card is positioned in proximity to the interface device. A menu engine is provided for traversing a menu structure based at least in part on user input at the interface device. An authentication module operatively associated with the menu engine requires smart card authentication before the menu engine traverses a secured branch in the menu structure.

### TECHNICAL FIELD

The described subject matter relates to building automation, and more particularly to smart card systems and methods for building automation.

### BACKGROUND

The ability to automatically control one or more functions in a building (e.g., lighting, heating, air conditioning, security systems) is known as building automation. Building automation may be used, for example, to automatically operate various lighting schemes in a house. Of course building automation may be used to control any of a wide variety of other automation devices, more or less elaborate than lighting controls.

Keypad or other similar input devices are typically provided in building automation for allowing the user to control the automation devices. Although keypads may be customized for a particular room in the building, the keypads typically cannot be customized for each of the potential different users. For example, a keypad installed in the living room may be programmed with predetermined lighting schemes for the living room, but the keypad provides the same controls for every user.

In addition, keypads may not provide protection, or may not provide sufficient protection, against unauthorized access to the automation devices. Although the user may be required to enter a pass code before accessing various automation devices, this can be cumbersome to the user and discourage use of the keypad.

### SUMMARY

Implementations described and claimed herein provide smart card systems and methods for building automation. In an exemplary implementation, a system is provided including an interface device communicatively coupled to a plurality of automation devices. Control circuitry is provided for the interface device to receive user credentials from a smart card when the smart card is positioned in proximity to the interface device. The exemplary system also includes a menu engine for traversing a menu structure based at least in part on user input at the interface device. An authentication module is operatively associated with the menu engine. The authentication module requires smart card authentication before the menu engine traverses a secured branch in the menu structure.

In another implementation, a method is provided. An exemplary method includes entering an interactive session with a user and a smart card at an interface device, traversing a menu structure based at least in part on input received at the interface device from the user, and requiring smart card authentication before traversing a secured branch in the menu structure.

### BRIEF DESCRIPTION OF THE DRAWINGS

FIG. 1 is a high level illustration of an exemplary building automation system in which smart card systems and methods may be implemented.

FIG. 2a shows an exemplary smart card.

FIG. 2b shows an exemplary interface device.

FIG. 2c shows an alternative exemplary interface device.

FIG. 3 is a schematic illustration of exemplary functional components of an interface device.

FIG. 4 is a high level illustration of an exemplary menu structure.

FIGS. 5a and 5b illustrate a portion of an interactive session.

FIG. 6 is a flow chart illustrating exemplary operations for implementing smart card methods for building automation.

### DETAILED DESCRIPTION

In exemplary implementations shown and described herein an interface device (e.g., a thin film transistor (TFT) touch-panel display, keypad, audio control, or other device) with smart card capabilities may supplement or altogether replace conventional controllers for automation devices in building automation. The interface device may include a low cost radio frequency (RF) antenna and control circuitry for interfacing with the smart card.

In operation a user positions a smart card in proximity to the interface device. Regardless of the current content being displayed by the interface device a custom interactive session begins (or resumes) based on information contained on the user's smart card. The interactive session proceeds by traversing a menu structure. During the custom interactive session, the user may be required to supply credentials before being able to access secured branches of the menu structure (e.g., security devices or another user's audio setup). These credentials may be contained on the smart card for the convenience of the user so that the user only needs to position their smart card in proximity to the interface device to supply the credentials. The user may be granted partial access based on the credentials supplied by the user's smart card. For example, various menu options may be “grayed out” for a particular user.

For purposes of illustration, the smart card systems and methods described herein may be implemented in a home automation system to provide user specific access to various automation devices. For example, parents may desire complete control for themselves over all automation devices and/or automation subsystems, but may only want to grant limited privileges to children or visitors. The smart card systems and methods may be configured to restrict access to various devices while providing custom access to other devices (e.g., direct access to the children's music library but not to the parent's preferred music settings).

As another illustration, a smart card may allow the user access to different automation devices depending on their location. For example, the user may use their smart card to access the HVAC controls in their own room, along with their music selections. The same smart card may be used to access their music selections in another room, but does not permit access the HVAC controls in the other room.

In still other exemplary implementations, the smart card systems and methods described herein may also authenticate user permissions at individual interface devices because authentication credentials and lists of authentication credentials are provided on the RFID card itself. According to exemplary implementations, the interface device does not need to access a central database to authenticate the user. Even if the central database is offline or otherwise unavailable, the user may still access the building automation system via the interface device.

It is noted that the smart card systems and methods described herein may also be implemented in any of a wide variety of other building automation environments. For example, the smart card systems and methods may be implemented in a hotel or vacation rental to provide different privileges to guests, staff, and managers. It is also noted that the invention may also find application in a number of different types of other control environments now known or later developed.

Exemplary Systems

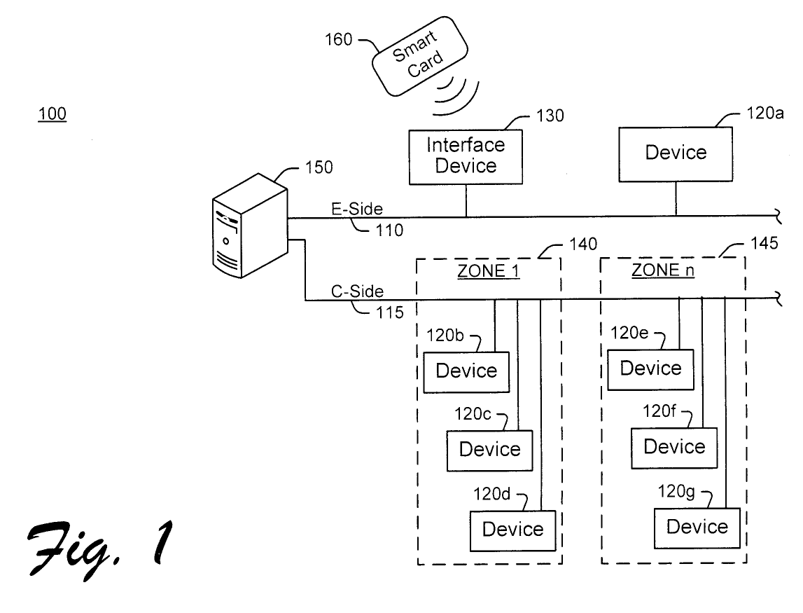

FIG. 1 is a high level illustration of an exemplary building automation system 100 in which smart card systems and methods may be implemented. By way of example, the building automation system 100 may be used to control lighting, heating, air conditioning, audio/visual distribution, operating window coverings to open/close, and security, to name only a few examples.

Building automation system 100 may include one or more communication networks, such as Ethernet network 110 (referred to herein as the “E-Side”) and a controller area network or CAN bus 115 (referred to herein as the “C-Side”). Ethernet networks are well understood. Implementations of a building automation system including a CAN bus are described in more detail in co-owned U.S. patent application Ser. No. 10/382,979, entitled “Building Automation System and Method” of Hesse, et al. filed on Mar. 5, 2003.

Briefly, the CAN bus may be implemented using a two-wire differential serial data bus. The CAN bus is capable of high-speed data transmission (about 1 Megabits per second (Mbits/s)) over a distance of about 40 meters (m), and can be extended to about 10,000 meters at transmission speeds of about 5 kilobits per second (kbits/s). It is also a robust bus and can be operated in noisy electrical environments while maintaining the integrity of the data.

It is noted that building automation system 100 is not limited to use with any particular type of communications network. Other networks may include, e.g., RS-232 networks, and wireless networks to name only a few examples.

Building automation system 100 may include one or more automation devices 120a-g (hereinafter generally referred to as automation devices 120). The automation devices 120 may include any of a wide range of types and configurations of devices. Examples include, e.g., security devices, environmental controls, lighting controls, timers, touch pads, and voice recognition devices, to name only a few.

Building automation system 100 may also include one or more interface devices 130. Interface device 130 may be implemented, e.g., as a TFT touch panel display, although other implementations are also contemplated including but not limited to keypads, audio control, and other devices. Interface device 130 may be used to control one or more automation devices 120 in the building automation system 100 during an interactive session, as described in more detail below.

Optionally, automation devices 120 may be provided in zones or automation subsystems 140, 145. Subsystems 140, 145 may be defined geographically, such as by room (e.g., the living room) or group of rooms (e.g., the first floor of a house). Alternatively, subsystems may be defined by functionality, such as security devices or lighting devices. subsystems may also be defined by user, such as a parent's multimedia devices and a child's multimedia devices. In any event, any number of subsystems 140, 145 may be defined for the building automation system 100 and interface device 130 may be implemented to control devices in any one or more of the subsystems 140, 145.

Automation devices 120 and the interface device 130 may be communicatively coupled to one another in the building automation system 100 via a bridge 150 to facilitate communications between the different types of networks. The term “bridge” as used herein refers to both the hardware and software (the entire computer system) and may be implemented as one or more computing systems, such as a server computer.

It is noted that the bridge 150 may also perform various other services for the building automation system 100. For example, bridge 150 may be implemented as a server computer to process commands for automation devices and the interface device 130, provide Internet and email services, broker security, and optionally provide remote access to the building automation system 100.

Building automation system 100 may also include one or more smart cards 160 which may be communicatively coupled to the interface device 130. The term “smart card” as used herein is defined as an electronic device containing at least an electronic memory and may also include processing capability (e.g., an integrated circuit).

Smart cards 160 contain information and/or credentials which may be used to identify the user, the user's preferences, and/or the user's privileges. Smart cards 160 provide a convenient method for authenticating the user before allowing the user to access, configure, and/or control some or all of the automation devices 120 in the building automation system 100, as will be described in more detail below.

It is noted that the building automation system 100 is not limited to any particular type or configuration. The foregoing example is provided in order to better understand one type of building automation network in which the smart card systems and methods described herein may be implemented. However, the systems and methods may also be implemented in other types of building automation systems. The particular configuration may depend in part on design considerations, which can be readily defined and implemented by one having ordinary skill in the art after having become familiar with the teachings of the invention.

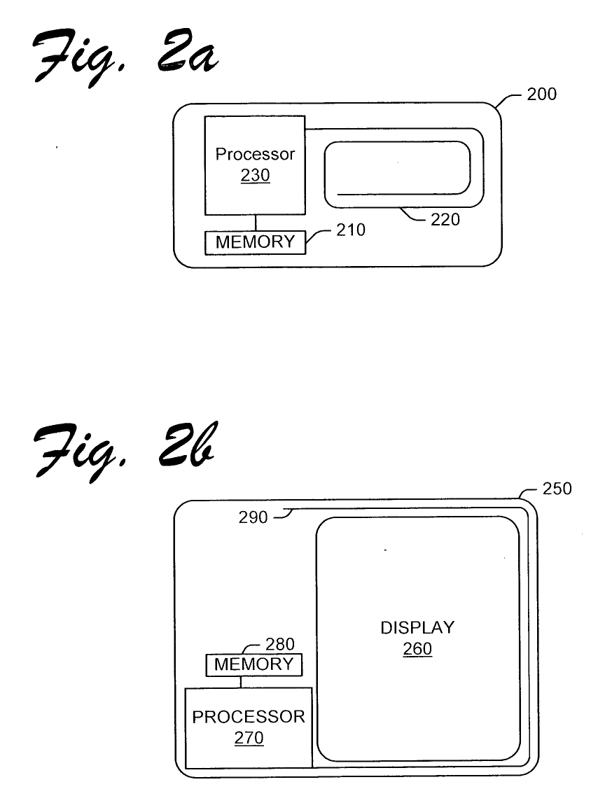

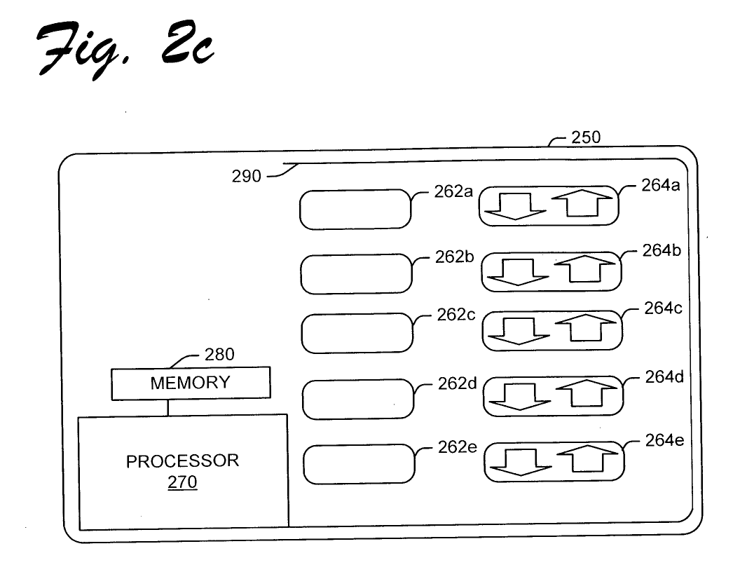

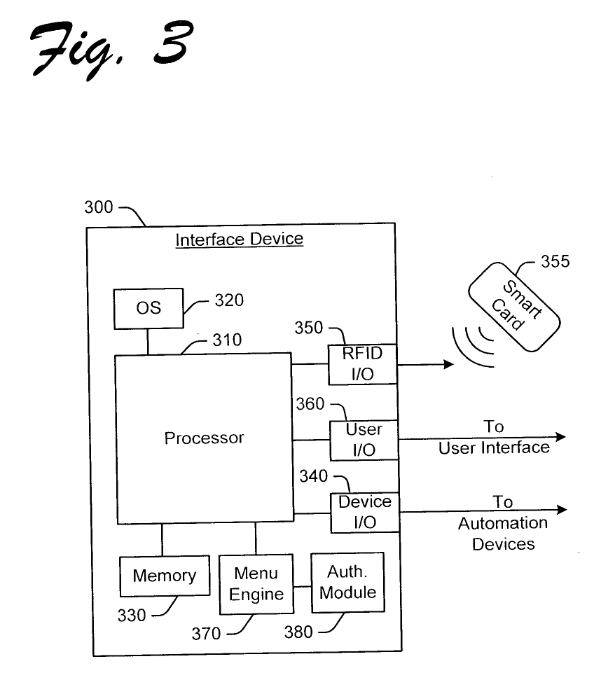

FIG. 2a shows an exemplary smart card 200. Exemplary smart card 200 may be implemented using radio frequency identification (RFID) technology. Smart card 200 may include at least a memory 210 and antenna 220 encased, e.g., in a plastic substrate similar to a credit card. Antenna 220 provides a communications link from the memory 210 to an RFID reader (e.g., provided in the interface device 250 shown in FIG. 2b). Optionally, smart card 200 may also include a processor 230, integrated circuit (not shown), or other processing capability for read/write operations on memory 210. In an exemplary implementation, the processor, antenna, and/or memory may be provided as one or more transponders mounted in the smart card 200.

Memory 210 may be implemented to contain information and/or credentials which may be used to identify the user, the user's preferences, and/or the user's privileges. By way of example, memory 210 may contain user identification information, user preference information, and/or user authentication credentials. Exemplary information and credentials that may be contained on a smart card (e.g., in memory 210) are shown in Table 1.

TABLE 1
Exemplary Smart Card Information and Credentials

| Information Type | Data Value |
|---|---|
| User ID | Homeowner |
| Password List | XXXXXX |
| | XXXXXX |
| | XXXXXX |
| Authorization List | Security - OFF |
| | Lighting - ON |
| | Audio - ON |
| | HVAC - ON |
| | Windows - ON |

In other implementations, information contained on the smart card 200 may be linked to additional information stored at the interface device 250 or elsewhere in the building automation system (e.g., at bridge 150 in FIG. 1). For example, a user ID contained on the smart card 200 may be linked to user preferences for various settings in the building automation system, such as, e.g., preferred lighting schemes, preferred music, etc.

FIG. 2b shows an exemplary interface device 250 which may be linked to smart card 200 in FIG. 2a. Exemplary interface device 250 may be implemented as a thin film transistor (TFT) touch panel display, wherein touch sensitive controls or “buttons” are displayed as graphical icons or text on a display 260. Commercially available touch-sensitive techniques include resistive circuitry wherein pressure is required to short spaced membranes, and capacitive circuitry wherein pressure is not required and instead a connection to the body de-tunes the capacitance. The icons may be selected using a pointing device (e.g., a stylus) or the user may simply touch the TFT screen 260 with his or her finger.

Processor 270 and memory 280 may also be provided to implement the smart card technology. In an exemplary implementation, processing capability and memory are provided as a transponder mounted in the housing of the TFT display. For example, the transponder may be mounted adjacent the display 260 as shown in FIG. 2b. In other implementations the transponder may be mounted, e.g., behind the display or in a separate housing from the display. An antenna 290 may be wound around the display 260, or in any other suitable position which allows a communication link to be established between the smart card 200 and the interface device 250 during operation.

FIG. 2c shows an alternative exemplary interface device 252 which may be linked to smart card 200 in FIG. 2a. Exemplary interface device 252 may be implemented as a keypad, wherein mechanical buttons are provided for the user to select with his or her finger. For purposes of illustration, push buttons 262a-e and corresponding rocker buttons 264a-e are shown. However, it is understood that any number and/or type of buttons may be provided for interface device 252, such as, e.g., switches and sliders. Input/output devices at the interface device may also include microphones, speakers, and sensors (e.g., temperature or light sensors).

Again, processor 272 and memory 282 may also be provided to implement the smart card technology. An antenna 292 may be wound around the keypad buttons 262 and 264, or in any other suitable position which allows a communication link to be established between the smart card 200 and the interface device 252 during operation. Interface device 252 may be operated in conjunction with the smart card 200 to enable some or all of the buttons 262, 264, as explained in more detail below.

It is noted that the RFID implementation described above with reference to FIGS. 2a-c may include passive or active RFID technology. In addition, more than one transponder may be provided in the smart card 200 and/or interface device 250 (e.g., as a backup).

It is also noted that the interface devices 250, 252 may also serve as a housing for the smart card reader in the building automation system even when the smart card is not used to control functions at the keypad. For example, the interface devices 250, 252 may house smart card readers which function simply to unlock doors in the building automation system. In such an implementation, the interface devices 250, 252 serve as convenient housing for the smart card reader without having to provide a separate housing and connection to the building automation system for the smart card reader.

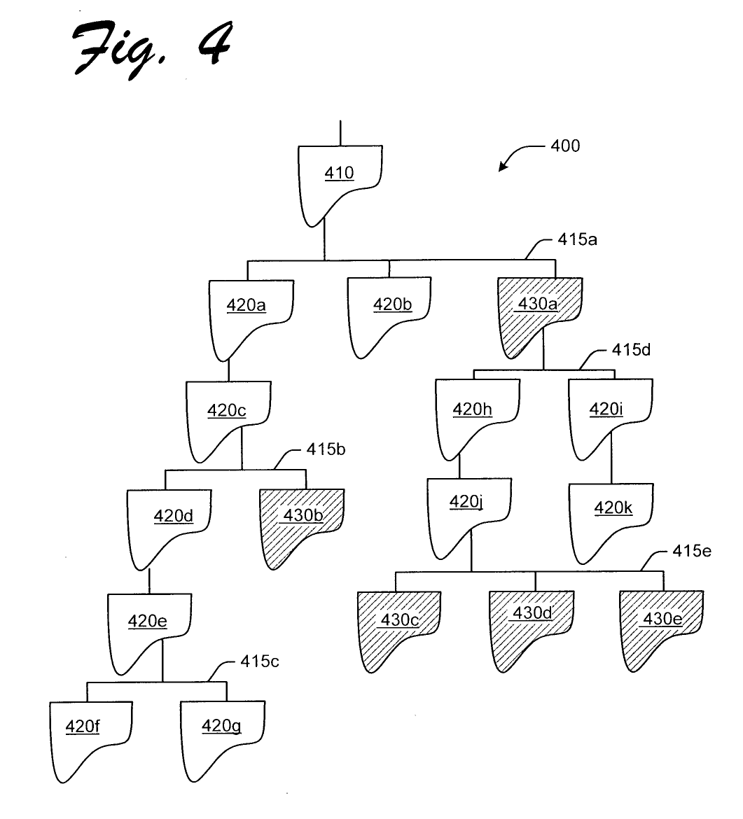

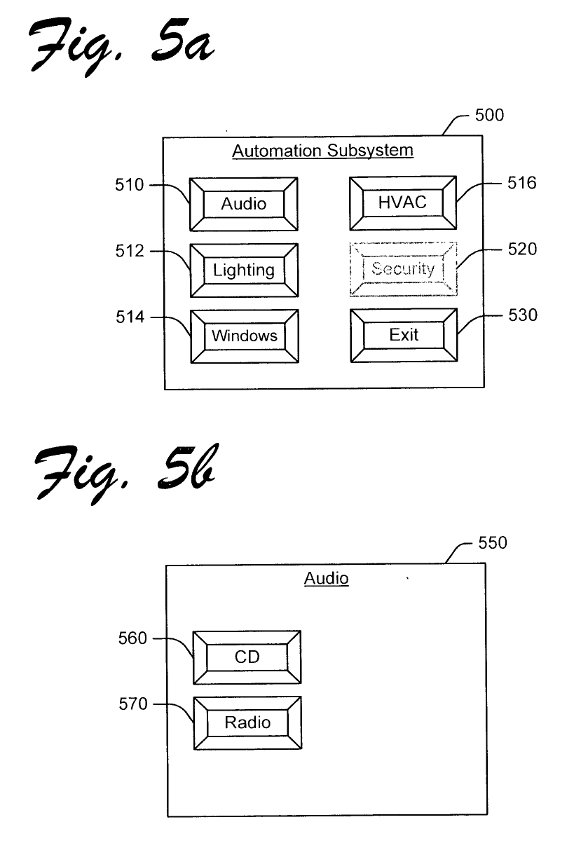

FIG. 3 is a schematic illustration of exemplary functional components of an interface device 300. Interface device 300 may include a processor or processing units 310 and an operating system 320 (e.g., Linux). Processor 310 is operatively associated with computer readable storage or memory 330.

Interface device 300 may also include a number of I/O ports operatively associated with processor 310. In an exemplary implementation, a device I/O 340 is provided for sending and/or receiving signals from one or more automation devices. An RFID I/O 350 (or other suitable remote protocol) may also be provided for sending and/or receiving signals from a smart card 355. Interface device 300 may also include a user I/O 360, such as, e.g., a TFT screen for displaying output and/or receiving user input, buttons on a mechanical keypad, etc.

Interface device 300 may include a user interface (UI) for interfacing with a user and the smart card 355. An exemplary user interface is described in more detail below with reference to FIG. 4. Interface device 300 may provide an interactive session for a user by traversing a menu structure. A menu engine 370 may be implemented as program code for reading and displaying menu options in response to input received from the user and/or smart card 355. Menu engine 370 may also include program code for generating signals to control automation devices in response to input received at the interface device 300.

Interface device 300 may also include an authentication module 380. Authentication module 380 may be implemented as program code which is called in response to receiving a request to access a secured branch in the menu structure. Authentication module 380 may require smart card authentication before allowing the user to access the secured branch.

To illustrate operation, a user may press a “hot” area on a TFT screen corresponding to a graphical button displayed on the user interface to activate a lighting control device. The user input may be received at the interface device 300 via user I/O 360. In response to this input, menu engine 370 may traverse a menu structure and display another page for the user (via user I/O 360) indicating that the button has been selected. If the user attempts to access a secured branch (e.g., the security subsystem), authentication module 380 may require smart card authentication before proceeding. The user must then position the smart card 355 in proximity to the interface device 300 to establish a link therebetween. Authentication module 380 then verifies that the user has the requisite credentials for accessing the secured branch.

Menu engine 370 may also cause a signal to be issued (e.g., on CAN bus 115 in FIG. 1) identifying a user selection from the menu structure to the automation devices. For example, a lighting control device in the building automation system may receive the signal and execute corresponding program code (e.g., scripts) residing at the lighting control device to cause the lights to be turned on to a predetermined lighting level.

FIG. 4 is a high level illustration of an exemplary menu structure 400. Exemplary menu structure 400 may be implemented as a data structure including a start page 410 and a plurality of menu options 420a-k (hereinafter generally referred to as menu options 420). The menu structure 400 may also include a number of branches 415a-e (e.g., hereinafter generally referred to as branches 415). A user may traverse the menu structure 400 by selecting menu options 420 to access automation devices and/or automation subsystems.

Each menu option 420 is represented in FIG. 4 as data and may be implemented, e.g., as XML objects. It is noted, however, that the menu structure 400 is not limited to use in a graphical user interface (GUI) operating environment. The menu structure 400 may also be implemented with other interface devices, such as, a keypad device with mechanical buttons, audio controls, etc.

The menu structure 400 may be customized for one or more users. In an exemplary implementation, a custom menu structure may include menu options that are only available to a particular user. In another exemplary implementation, a general menu structure may be used for each user, but access to various menu options may be limited for different users.

Menu structure 400 may be stored in memory operatively associated with the interface device (e.g., at memory 330 in FIG. 3). In an exemplary implementation, a backup of the menu structure 400 may also be stored (e.g., at the bridge 150 in FIG. 1) so that the menu structure may be automatically reloaded if an interface device is replaced.

A menu engine (such as the menu engine 370 in FIG. 3) may be implemented as computer-readable program code (or software) to provide the menu options 420 to the user at an interface device and to traverse the menu structure 400 in response to input received at the interface device (e.g., from the user, smart card, or other devices in the building automation system).

In operation, the interface device may be activated, e.g., by user input and/or positioning a smart card in proximity to the interface device. During activation, program code (e.g., the menu engine) calls a menu structure 400 from memory. The menu engine may call a general menu structure or a menu structure specific to a user (e.g., as identified by information contained in the smart card).

In an exemplary implementation, the menu engine may display one or more starting options 410 upon activation. The user may select from menu options on the start page (e.g., those on branch 415a) to access automation subsystems and/or automation devices. By way of example, the user may select an audio subsystem, and the menu engine then displays menu options 420 for the audio subsystem. The user may select a menu option 420 to increase the volume, wherein a signal may be issued to an audio controller to increase the volume.

Program code (e.g., authentication module 380 in FIG. 3) may require smart card authentication if the user attempts to access a secured branch of the menu structure via menu options 430a-e (hereinafter generally referred to as restricted menu options 430). If the smart card authentication is successful (e.g., the smart card contains the requisite credentials), the menu engine traverses the menu structure and provides access to the secured branch. If the smart card authentication is unsuccessful (e.g., the smart card does not contain the requisite credentials), the user is denied access to the secured branch.

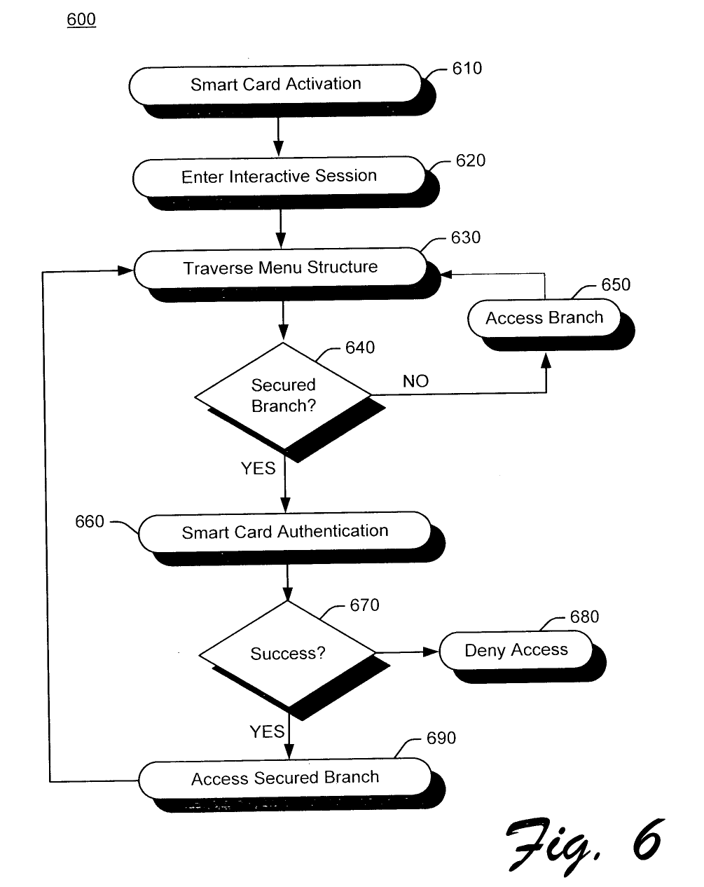

FIGS. 5a and 5b illustrate a portion of an interactive session. Exemplary output 500 in FIG. 5a includes menu options for accessing various automation subsystems, such as may be presented to the user in response to activating the interface device.

Menu options may be selected from a menu structure (e.g., menu structure 400 in FIG. 4). As discussed above, menu structure may include user-specific menu options, e.g., based on information contained on the user's smart card. In FIG. 5a, menu options include access to an audio subsystem 510, a lighting subsystem 512, a window subsystem 514, and an HVAC subsystem 516. One or more menu options may be “grayed out” if the user does not have access privileges to the automation subsystem. For example, the security menu option 520 is shown grayed out to indicate that the user does not have access privileges to the security subsystem or that the security subsystem is restricted. A menu option 530 for exiting the menu structure is also shown.

The user may select one of the menu options in FIG. 5a to access an automation subsystem. The user's selection causes the menu engine to traverse the menu structure. For example, if the user selects the audio subsystem 510 the menu engine may traverse the menu structure to display output 550 (in FIG. 5b) including menu options 560, 570 for the audio subsystem. The user may then select a menu option from the audio subsystem (e.g., to access the CD player or radio).

It is noted that the menu options shown and described with reference to FIGS. 5a and 5b are merely illustrative. Other implementations are also contemplated and are not limited to a GUI-enabled interface device. For example, the interface device may be implemented as a keypad having mechanical buttons with dynamic menu options which change as the user traverses the menu structure. An LCD display may also be provided.

Exemplary Operations

FIG. 6 is a flow diagram illustrating operations 600 to implement smart card methods for building automation. The methods described herein may be embodied in control circuitry and as logic instructions.

In operation 610 the interface device may be activated using a smart card. It is noted that in other implementations the interface device may also be activated manually (e.g., by pressing a button), by speech, by motion, etc. In operation 620 an interactive session begins with a user and a smart card at the interface device. In operation 630 a menu structure may be traversed based at least in part on input received at the interface device from the user. It is noted that input may include manual input (e.g., pressing a button), speech, smart card input, etc.

In operation 640 a determination is made whether a branch of the menu structure is a secured branch. If the branch a user is attempting to access is not a secured branch, the user may be provided access to the branch in operation 650. The process may then return to operation 630 to continue traversing the menu structure.

Alternatively, if the branch a user is attempting to access is a secured branch, smart card authentication may be required in operation 660 before access is provided to the secured branch in the menu structure. A determination is made in operation 670 whether the smart card authentication succeeded. If smart card authentication failed access may be denied in operation 680. Alternatively, if authentication succeeded then the user may be provided access to the secured branch in operation 690. The process may then return to operation 630 to continue traversing the menu structure.

It is noted that denying access in operation 680 may be implemented in a number of different ways. For example, denying access may include requesting the user to “Try Again,” returning the user to the previous menu, or even locking the user out of the system altogether (e.g., after X number of failed attempts).

It is also noted that accessing the secured branch in operation 690 may include providing only limited access to the secured branch. For example, a user may only be provided “Audit” privileges for the security system based on the credentials supplied during smart card authentication, wherein the user is allowed to view the current security settings but is not allowed to make any changes to the security settings.

In addition to the specific implementations explicitly set forth herein, other aspects and implementations will be apparent to those skilled in the art from consideration of the specification disclosed herein. It is intended that the specification and illustrated implementations be considered as examples only, with a true scope and spirit of the following claims.

What is claimed is:

1. A smart card system for building automation, comprising:
an interface device communicatively coupled to a plurality of automation devices;
control circuitry provided for the interface device to receive user credentials from a smart card when the smart card is positioned in proximity to the interface device;
a menu engine for traversing a menu structure based at least in part on user input at the interface device; and
an authentication module operatively associated with the menu engine, the authentication module requiring smart card authentication before the menu engine traverses a secured branch in the menu structure.

2. The building automation system of claim 1, wherein the menu engine provides a custom interactive session at the interface device.

3. The building automation system of claim 2, wherein the custom interactive session is based on a user identification contained in the smart card.

4. The building automation system of claim 1, wherein the control circuitry includes an RFID antenna wound around a TFT display.

5. The building automation system of claim 1, wherein the menu engine traverses the menu structure based at least in part on smart card input.

6. The building automation system of claim 1, wherein the menu engine blocks access to the secured branch of the menu structure if the smart card authentication fails.

7. The building automation system of claim 1, wherein the menu engine provides partial access to the secured branch of the menu structure based on the smart card authentication.

8. The building automation system of claim 1, wherein the menu engine selects a branch of the menu structure based on input received from the smart card.

9. A smart card method for building automation, comprising:
entering an interactive session with a user and a smart card at an interface device;
traversing a menu structure based at least in part on input received at the interface device from the user; and
requiring smart card authentication before traversing a secured branch in the menu structure.

10. The method of claim 9, wherein the menu structure provides user-specific access to a building automation system.

11. The method of claim 9, further comprising providing the user with a custom interactive session based on identifying the user by the smart card.

12. The method of claim 9, wherein entering the interactive session is based on user activation of the interface device.

13. The method of claim 9, wherein entering the interactive session is based on smart card activation of the interface device.

14. The method of claim 9, wherein traversing the menu structure is based at least in part on smart card input received at the interface device.

15. The method of claim 9, further comprising blocking access to the secured branch of the menu structure if the smart card authentication fails.

16. The method of claim 9, further comprising providing limited access to the secured branch of the menu structure based on the smart card authentication.

17. The method of claim 9, wherein at least one secured branch of the menu structure is a configuration branch for the interface device.

18. The method of claim 9, wherein at least one secured branch of the menu structure is a configuration branch for an automation device in a building automation system.

19. The method of claim 9, wherein at least one secured branch of the menu structure is a configuration branch for an automation subsystem in a building automation system.

20. A smart card system for providing user-specific access to automation devices, comprising:
means for conducting an interactive session with a user and a smart card;
means for traversing branches in a menu structure during the interactive session; and
means for requiring smart card authentication before the means for traversing accesses a secured branch in the menu structure.
